(19) United States
(12) Patent Application Publication
(10) Pub. No.: US 2026/0320667 A1
(43) Pub. Date: Oct. 15, 2026

(54) INTERACTION METHOD AND APPARATUS, ELECTRONIC DEVICE, AND STORAGE MEDIUM

(71) Applicant: Beijing Youzhuju Network Technology Co., Ltd., Beijing (CN)

(72) Inventors: Yingyuan CHEN, Beijing (CN); Fanke CHENG, Beijing (CN)

(21) Appl. No.: 19/483,223

(22) PCT Filed: Jun. 28, 2024
(86) PCT No.: PCT/CN2024/102523

§ 371 Date: Nov. 10, 2025

(30) Foreign Application Priority Data
Jul. 27, 2023 (CN) 202310934206.0

(51) Int. Cl. G06Q 30/0601; G06F 3/04842

(52) U.S. Cl. CPC G06Q 30/0631; G06F 3/04842; G06Q 30/06333; G06Q 30/0641

(57) ABSTRACT

Embodiments of the present disclosure provide an interaction method, apparatus, electronic device and storage medium. The method includes: displaying object information of a to-be-recommended object of a current user on a first object page; displaying at least one addition control in response to a control display operation, where different addition controls correspond to different object recommendation sets, and the different object recommendation sets support different recommendation methods to recommend an added object; adding a target to-be-recommended object to a target object recommendation set of the current user in response to a trigger operation on a target addition control in the at least one addition control, where the target to-be-recommended object is a to-be-recommended object that is selected by the current user on the first object page, and the target object recommendation set is an object recommendation set corresponding to the target addition control.

This application claims the priority to and benefits of Chinese Patent Application No. 202310934206.0, filed on Jul. 27, 2023, and the aforementioned patent application is incorporated herein by reference in its entirety.

### TECHNICAL FIELD

Embodiments of the present disclosure relate to an interaction method, an apparatus, an electronic device, and a storage medium.

### BACKGROUND

At present, in some platforms, users can make product recommendations based on candidate products provided by the platform. However, the commodity recommendation method is relatively simple.

### SUMMARY

Embodiments of the present disclosure provide an interaction method, a device, an electronic device, and a storage medium to enrich the recommendation method of commodities.

According to a first aspect, embodiments of the present disclosure provide an interaction method, the interaction method includes:
displaying object information of a to-be-recommended object of a current user on a first object page;
displaying at least one addition control in response to a control display operation, different addition controls correspond to different object recommendation sets, and the different object recommendation sets support different recommendation methods to recommend an added object;
adding a target to-be-recommended object to a target object recommendation set of the current user in response to a trigger operation on a target addition control in the at least one addition control, the target to-be-recommended object is a to-be-recommended object that is selected by the current user on the first object page, and the target object recommendation set is an object recommendation set corresponding to the target addition control.

In a second aspect, embodiments of the present disclosure further provide an interaction apparatus, the interaction apparatus includes:
a first display module, configured to display object information of a to-be-recommended object of a current user on a first object page;
a control display operation, configured to display at least one addition control in response to a control display operation, different addition controls correspond to different object recommendation sets, and the different object recommendation sets support different recommendation methods to recommend an added object;
a first addition module, configured to add a target to-be-recommended object to a target object recommendation set of the current user in response to a trigger operation on a target addition control in the at least one addition control, the target to-be-recommended object is a to-be-recommended object that is selected by the current user on the first object page, and the target object recommendation set is an object recommendation set corresponding to the target addition control.

According to a third aspect, embodiments of the present disclosure further provides an electronic device, the electronic device includes:
at least one processor;
a memory communicatively connected to the at least one processor;
the memory stores computer programs executable by the at least one processor, the computer programs are executed by the at least one processor so that the at least one processor performs the interaction method as described in embodiments of the present disclosure.

According to a fourth aspect, embodiments of the present disclosure further provides a computer-readable storage medium having computer programs stored thereon, and when the programs are executed by a processor, the interaction method described in the embodiments of the present disclosure is realized.

### BRIEF DESCRIPTION OF DRAWINGS

The above and other features, advantages, and aspects of various embodiments of the present disclosure will become more apparent when taken in conjunction with the accompanying drawings and referring to of the following Detailed Description. Throughout the drawings, the same or similar reference numerals denote the same or similar elements. It should be understood that the drawings are schematic and that originals and elements are not necessarily drawn to scale.

FIG. 1 is a schematic flow diagram of an interaction method provided by an embodiment of the present disclosure;

FIG. 2 is a schematic diagram showing a first object page provided by an embodiment of the present disclosure;

FIG. 3 is a schematic display diagram of an addition control according to an embodiment of the present disclosure;

FIG. 4 is a schematic flow diagram of another interaction method provided by an embodiment of the present disclosure;

FIG. 5 is a schematic diagram showing a recommendation information input page provided by an embodiment of the present disclosure;

FIG. 6 is a structural block diagram of an interaction apparatus provided by an embodiment of the present disclosure; and

FIG. 7 is a schematic structural diagram of an electronic device provided by an embodiment of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be embodied in various forms and should not be construed as limited to the embodiments set forth herein, but rather are provided for a more thorough and complete understanding of the present disclosure. It should be understood that the drawings and embodiments of the present disclosure are for illustrative purposes only, and are not intended to limit the scope of protection of the present disclosure.

It should be understood that the various steps described in the method embodiments of the present disclosure may be performed in different orders, and/or in parallel. Furthermore, method embodiments may include additional steps and/or omit performing the illustrated steps. The scope of the present disclosure is not limited in this respect.

As used herein, the term “including” and variations thereof are open-encompassing, i.e., “including but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions of other terms will be given in the following description.

It should be noted that the concepts such as “first” and “second” mentioned in the present disclosure are only used to distinguish different devices, modules, or units, and are not used to limit the order or interdependence of functions performed by these devices, modules, or units.

It should be noted that the modifications of “one” and “a plurality” mentioned in the present disclosure are schematic and not limiting, and should be understood by those skilled in the art as “one or more” unless otherwise explicitly indicated in the context.

The names of messages or information interacted between multiple devices in embodiments of the present disclosure are for illustrative purposes only, and are not intended to limit the scope of these messages or information.

It can be understood that before using the technical solutions disclosed in each embodiment of the present disclosure, users should be informed of the types, usage scope, usage scenarios, etc. of the personal information involved in the present disclosure in an appropriate manner in accordance with relevant laws and regulations, and authorization from the users should be obtained.

For example, in response to receiving an active request from the user, prompt information is sent to the user to explicitly prompt the user that the operation it requests to perform will require the acquisition and use of the user's personal information. Accordingly, the user can autonomously select whether or not to provide personal information to software or hardware such as electronic device, application, a server, or storage medium that performs the operation of the technical solution of the present disclosure according to prompt information.

As an optional but non-limiting implementation, in response to receiving an unsolicited request from the user, the manner of sending prompt information to the user may be, for example, the manner of pop-up window, and the pop-up window may be presented in text in the prompt information. In addition, the pop-up window can also carry an optional control for users to choose “agree” or “disagree” to provide personal information to electronic device.

It is to be understood that the above-described procedures of notifying and obtaining user authorization are merely illustrative and do not limit the implementation forms of the present disclosure, and other methods satisfying relevant laws and regulations can also be applied to the implementation forms of the present disclosure.

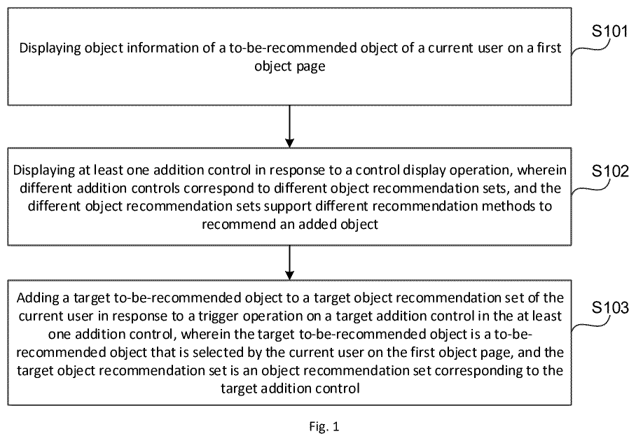

FIG. 1 is a schematic flow diagram of an interaction method according to an embodiment of the present disclosure. The method may be performed by an interaction apparatus, the apparatus may be implemented by software and/or hardware, may be configured in an electronic device, for example, may be configured in a mobile phone or tablet. The interaction method provided by the embodiment of the present disclosure is applicable to a scenario in which a to-be-recommended object in the first object page is added to an object recommendation set. As shown in FIG. 1, the interaction method provided by the present embodiment may include:

S101: displaying object information of a to-be-recommended object of a current user on a first object page.

The current user may be considered to be a user who currently views his own first object page, and optionally, the current user may be a user who has the first object page in the current application, such as a user who has the right to recommend a to-be-recommended object in the current application. The first object page may be page for displaying an object selected by the current user that may have a willingness to recommend; the to-be-recommended object in the first object page may be an object that the current user may have a willingness to recommend, such as an object that the current user initially selects to recommend, in other words, an object that the current user plans to recommend, which may be added to the first object page by the current user.

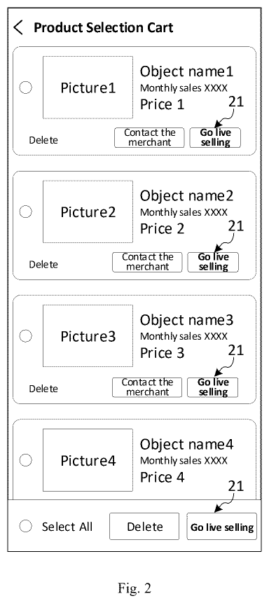

In the present embodiment, the first object page of the current user may be displayed, and the object information of the to-be-recommended object is added by the current user on the first object page may be displayed on the first object page, and the object information of at least part of the to-be-recommended object of the current user may be displayed on the first object page, as shown in FIG. 2. The object information may include, for example, information such as picture, name, sales volume, and/or price of the to-be-recommended object, and may further include information such as income that the current user can obtain after recommending the to-be-recommended object.

S102, displaying at least one addition control in response to a control display operation, where different addition controls correspond to different object recommendation sets, and the different object recommendation sets support different recommendation methods to recommend an added object.

The control display operation may be a trigger operation for instructing display of addition control, such as a trigger operation that triggers the recommendation control displayed in the first object object page, or the like. The addition control may be a control for indicating that the to-be-recommended object selected by the user in the first object page is added to the object recommendation set corresponding to the addition control. Different addition control may correspond to different object recommendation sets.

The object recommendation set may be a set of objects recommended by the current user, and the display mode of the object recommendation set is not limited, for example, the object recommendation set may be displayed in the form of list or other forms. In the present embodiment, the current user may have one or more object recommendation sets, and different object recommendation sets may correspond to different recommendation methods, for example, different recommendation methods may be used to recommend to-be-recommended objects in different object recommendation sets. Exemplarily, the object recommendation set may include a recommendation set that is displayed in association with one or more media content of the current user; other recommendation sets may be further included, such as recommendation sets that are displayed in a certain page of the current user.

In the present embodiment, when the control display operation of the user is received, at least one addition control corresponding to different object recommendation sets may be displayed, so that the user can add the selected to-be-recommended object to the object recommendation set that he wants to add.

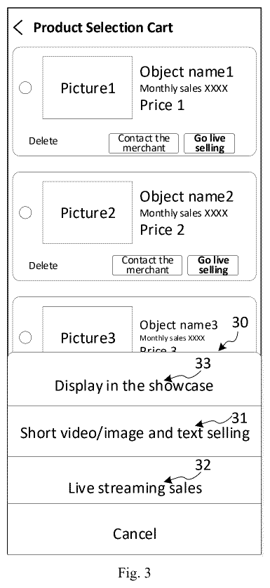

For example, as shown in FIG. 2, a recommendation control 21, such as a recommendation control 21 corresponding to each to-be-recommended object and/or a recommendation control corresponding to a to-be-recommended object in a selected state in the first object page, may be displayed in the first object page. Thus, when it is detected that the current user triggers the recommendation control 21 or moves an input indicator (such as a cursor) to the display position of the recommendation control 21, it may be determined that a control display operation has been received, in response to the control display operation, an addition control panel 30 is displayed, and at least one addition control is displayed in the addition control panel 30, as shown in FIG. 3.

It can be understood that, in some embodiments, when the first object page is displayed, at least one addition control may also be maintained to be displayed in the first object page without the user performing a control display operation.

S103, adding a target to-be-recommended object to a target object recommendation set of the current user in response to a trigger operation on a target addition control in the at least one addition control, where the target to-be-recommended object is a to-be-recommended object that is selected by the current user on the first object page, and the target object recommendation set is an object recommendation set corresponding to the target addition control.

Target addition control can be an addition control triggered by the current user, and there is no limit to the triggering method of target addition control. The target to-be-recommended object may be regarded as the to-be-recommended object in the first object page and added to the target object recommendation set as indicated by the target addition operation, such as the to-be-recommended object selected by the current user in the first object page, and the number thereof may be one or more. For example, when the current user performs a control display operation by triggering a recommendation control corresponding to a to-be-recommended object in the first object page, the target to-be-recommended object may be a target to-be-recommended object corresponding to the recommendation control triggered by the current user, and at this time, the number of target objects to be recommended may be one. When the current user performs the control display operation by triggering the recommendation control corresponding to the to-be-recommended object in the selected state, such as when the current user performs the control display operation by triggering the recommendation control at the bottom of the first object page shown in FIG. 2, the target to-be-recommended object may be to-be-recommended object in the selected state in the first object page, and at this time, the number of target objects to be recommended may be one or more.

The target object recommendation set can be regarded as an object recommendation set corresponding to the target addition control, that is, an object recommendation set indicating that the target to-be-recommended object is added to. The target object recommendation set can adopt a recommendation method associated with media content for object recommendation, such as an object recommendation set displayed when displaying a media screen or displayed based on the corresponding trigger operation of the audience; other recommendation methods may also be used for object recommendation, such as displaying objects in a certain page of the current user.

Specifically, when a certain addition control triggered by the current user is detected, the target to-be-recommended object selected by the current user in the first object page may be added to the target object recommendation set corresponding to the addition control, and the target to-be-recommended object may be recommended using the recommendation method corresponding to the target object recommendation set.

In the present embodiment, by using the first object page to carry the to-be-recommended objects that users initially determine as having recommendation intent, users can select to-be-recommended objects from their first object page and add them to different object recommendation sets. This eliminates the need to choose to-be-recommended objects each time from an object page provided by the platform that contains a large number of candidate objects, which can enrich the functionality of the first object page and diversify the ways in which to-be-recommended objects can be added to the recommendation sets.

In some optional embodiments, after the adding a target to-be-recommended object to a target object recommendation set of the current user, the interaction method further includes: generating associated display content of the target object recommendation set, the associated display content includes media content.

The associated display content of the target object recommendation set can be regarded as the target object recommendation set and its associated display content, and the associated display content can be media content, such as media content or live streaming media content post by the current user. Thus, when the associated display content of the target object recommendation set is displayed, the target object recommendation set may be further displayed or displayed based on a corresponding trigger operation of the audience watching the media screen.

In the present embodiment, when the target object recommendation set is an object recommendation set that is performed object recommendation by a recommendation method associated with media content, after the target to-be-recommended object is added to the preset object recommendation set of the current user, media content corresponding to the target object recommendation set may be generated so that the target object recommendation set may be displayed and associated when the media content is displayed.

Exemplarily, after adding the target to-be-recommended object to the current user's target object recommendation set, a page for generating media content associated with the display of the target object recommendation set may be displayed. The media content may then be generated based on the current user's media content creation operation on this page. Alternatively, after adding the target to-be-recommended object to the current user's target object recommendation set, a certain control may be displayed; when the current user is detected to trigger this control, a page for generating media content associated with the display of the target object recommendation set is shown, and the media content is generated within this page based on the current user's media content creation operation.

In the present embodiment, the user may select a to-be-recommended object in his first object page to add the to-be-recommended object to the preset object recommendation set, and generate a media screen corresponding to the preset object recommendation set after the addition is completed. Therefore, it is not necessary to first switch to the media screen generation page to generate the media screen when the to-be-recommended object is found, and after the media screen is generated, return to the object page again to find and add the to-be-recommended object, thereby enriching the way of adding the to-be-recommended object in the object recommendation set and simplifying the operation required for recommending the to-be-recommended object.

In some embodiments, after the adding a target to-be-recommended object to a target object recommendation set of the current user, the interaction method further includes at least one of the following: displaying the target object recommendation set; displaying addition information of the target to-be-recommended object, the addition information is used to indicate whether the target to-be-recommended object is successfully added and/or a reason why the target to-be-recommended object fails to be added.

The addition information of the target to-be-recommended object may be information for indicating whether the addition of the target to-be-recommended object is successful and/or a reason why the target to-be-recommended object fails to be added.

In the above-described embodiment, after the adding a target to-be-recommended object to a target object recommendation set of the current user, the addition information of the target object recommendation set and/or the target to-be-recommended object may be displayed so that the current user can view it. The addition information of the target object recommendation set and/or the target to-be-recommended object may be automatically displayed or displayed based on the corresponding trigger operation of the user, and this is not limited in the present embodiment.

For example, in a case where there is no target to-be-recommended object that fails to be added, the addition information may be displayed or not displayed, and when the addition information is displayed, the addition information may indicate that the current user target to-be-recommended object is successfully added. In a case where there is a target to-be-recommended object that fails to be added, addition information may be displayed, and the addition information indicates the existence of a target to-be-recommended object that fails to be added, the number of target to-be-recommended objects that have been successfully added and/or the target to-be-recommended objects that have failed to be added, the target to-be-recommended objects that have been successfully added and/or the target to-be-recommended objects that have failed to be added, and/or the reason why the target to-be-recommended object fails to be added.

Taking the target object recommendation set as an object recommendation set to be displayed in association with media content post by the current user, in a case where a target to-be-recommended object is added, when the target to-be-recommended object is successfully added, the addition information may not be displayed, and a subsequent interactive event may be executed, such as switching to media content generation page to generate target object to be post corresponding to the media content recommendation set, or switching to recommendation information input page for the current user to input recommendation information of the to-be-recommended object in the target object recommendation set; when the addition of the target to-be-recommended object fails, the first addition information may be displayed, and the failure of the addition of the target to-be-recommended object and the reason why the target to-be-recommended object fails to be added may be prompted by the first addition information.

In a case where a plurality of target to-be-recommended objects are added, when all target to-be-recommended objects are successfully added, the addition information may not be displayed, and the subsequent interaction event may be executed; when only part of the target to-be-recommended objects are added successfully or all of the target to-be-recommended objects fail to be added, the second addition information may be displayed, and the number of the target to-be-recommended objects that have been added successfully and the number of the target to-be-recommended objects that have failed to be added this time may be indicated, and the third addition information may be displayed when the detail view operation is received, the target to-be-recommended object fails to be added and the reason why the target to-be-recommended objects fails to be added may be indicated by the third addition information, and the third addition information may further indicates the target objects to be recommended that are successfully added. The details view operation may be understood as an operation for instructing display of the third addition information, such as an operation for triggering the details view control.

Further, when only a part of the target to-be-recommended object is successfully added, if a recommendation information for instructing media content to generate page or page to input trigger operation is received in the display process of the second added information and/or the third added information, it is possible to switch to media content to generate page to be post corresponding to the target object recommendation set, or to media content to input recommendation information for the current user to input page of the to-be-recommended object added in the preset object recommendation set.

In addition, when only a part of the target to-be-recommended object is successfully added, if a trigger operation for instructing to display a media content generation page or a recommendation information input page is received during the display of the second added information and/or the third added information, it is possible to switch to the media content generation page to generate the media content to be post corresponding to the target object recommendation set, or switch to the recommendation information input page for the current user to input recommendation information of the to-be-recommended object added in the preset object recommendation set.

Taking the target object recommendation set as an object recommendation set displayed in association with the live streaming media content as an example, in a case where a target to-be-recommended object is added, the fourth addition information may be displayed when the target to-be-recommended object is successfully added, the fourth addition information may prompt that the target to-be-recommended object is successfully added, and the live streaming central control page of the current user may be displayed and the target object recommendation set is displayed in the live streaming central page when a trigger operation for indicating the display of a target object recommendation set is received, such as when a trigger operation for triggering the live streaming central control is detected. When the addition of the target to-be-recommended object fails to be added, the fifth addition information may be displayed, and the addition failure of the target to-be-recommended object and the reason why the the target to-be-recommended object fails to be added may be prompted by the fifth addition information.

In a case where a plurality of target to-be-recommended objects are added, when all target to-be-recommended objects are successfully added, the sixth addition information may be displayed, the sixth addition information prompts that the target to-be-recommended objects are successfully added, and a live streaming central control page of the current user may be displayed when trigger operation for instructing display of the target object recommendation set is received, and the page recommendation set of the current user may be displayed in the live streaming central control page; when only part of the target to-be-recommended objects are successfully added, the seventh addition information may be displayed, through which the number of target to-be-recommended objects that are successfully added and the number of target to-be-recommended objects fails to be added in this addition are indicated, and upon receiving the view details operation, the eighth addition information may be displayed, through which indicates the target to-be-recommended objects fails to be added and the reason why each target to-be-recommended object fails to be added, in addition, target to-be-recommended object successfully added may be further indicated. When a trigger operation for instructing to display a target object recommendation set is received, the live streaming central control page of the current user is displayed, and the target object recommendation set of the current user is displayed in the live streaming central control page; when all arget to-be-recommended objects fail to be added, the seventh addition information can be displayed, and the number of target to-be-recommended objects that have been successfully added and the number of target to-be-recommended object that have failed to be added are indicated by the seventh addition information; and when a view details operation is received, the eighth addition information is displayed, and the target to-be-recommended object that have fails to be added and the reason why each target to-be-recommended object fails to be added are indicated by the eighth addition information.

When all target recommended objects fail to be added, seventh addition information indicating the number of target recommended objects successfully added this time and the number of target recommended objects that fail to be added this time may be displayed, and when the view details operation is received, eighth addition information indicating the target recommended objects that fail to be added and the reason for failing to add each target recommended object that fail to be added may be displayed.

In some embodiments, before the displaying object information of the to-be-recommended object of the current user in the first object page, the interaction method further includes: displaying a third object page, object information of at least one candidate recommendation object and a second control corresponding to a display theme of the third object page are displayed in the third object page; adding a first candidate recommendation object to the first object page of the current user in response to an object addition operation for the first candidate recommendation object in the at least one candidate recommendation object; and adding a second candidate recommendation object corresponding to the second control to an object recommendation set corresponding to the display theme in response to a trigger operation of the second control.

The third object page can be regarded as page used for displaying candidate recommendation objects, such as used for displaying page of candidate recommendation objects provided by platform. The candidate recommendation object may be considered to be an object provided by the platform for a user in the platform to select and recommend. The object page may include objects that the current user has not yet added to his first object page and/or objects that the current user has added to his first object page. The object addition operation may be an operation for indicating one or more candidate recommendation objects to be added to the first object page, such as an operation that triggers addition control of the first object page, or the like. The first candidate recommendation object may be understood as a candidate recommendation object corresponding to the object addition operation, that is, an object to which the object addition operation indicates to be added to the first object page of the current user. The second control may correspond to the display theme of the third object page, and is used to trigger an indication to add a corresponding candidate recommendation object to the object recommendation set corresponding to the display theme of the object page. The second candidate recommendation object may indicate, for the current user, a candidate recommendation object added to the first object page, such as a candidate recommendation object corresponding to the second control triggered by the current user and/or a candidate recommendation object in a selected state in the third object page.

Exemplarily, a third object page may be displayed, and information of at least one candidate recommendation object and a first object page addition control may be displayed in the third object page. Therefore, when it is detected that the current user triggers the first object page addition control corresponding to a candidate recommendation object, the candidate recommendation object may be added to the first object page of the current user.

In the above embodiment, one or more third object page may be set in the platform, and different third object page may correspond to different display themes, such as live streaming or window and etc. Accordingly, in the third object page a second control corresponding to the to-be-recommended object may be further displayed, and the second control may correspond to the display theme of the third object page for triggering an indication to add the corresponding candidate recommended object to the object recommendation set corresponding to the display theme of the third object page. Therefore, when a certain second control displayed in the current user trigger object page is detected, a candidate recommendation object corresponding to the second control may be added to the object recommendation set corresponding to the display theme of the currently displayed object page.

For example, when a third object page corresponding to live streaming theme is displayed, information of a to-be-recommended object and a second control associated with live streaming theme may be displayed in the third object page, and when it is detected that the current user triggers a second control displayed in the live streaming object page, a candidate recommendation object corresponding to the second control may be added to the object recommendation set displayed by the current user in association with the live streaming media content; when the third object page corresponding to the window theme is displayed, information of the to-be-recommended object and the second control associated with the window theme may be displayed in the third object page, and when it is detected that the current user triggers a second control displayed in the third object page, the candidate recommended object corresponding to the second control object is added to the object recommendation set displayed by the current user in the second object page. The object page corresponding to the live streaming theme may be a page for displaying candidate recommendation objects recommended based on the live streaming situation, such as a page for displaying candidate recommendation objects with better recommendation situation during the live streaming; the third object page corresponding to the window theme can be understood as a page for displaying candidate recommendation objects recommended based on the window addition situation, such as a page for displaying candidate recommendation objects added to an object recommendation set displayed in the second object page with a large number of times.

The interaction method provided by the present embodiment, displaying object information of a to-be-recommended object of a current user on a first object page; displaying at least one addition control in response to a control display operation, different addition controls correspond to different object recommendation sets, and the different object recommendation sets support different recommendation methods to recommend an added object; adding a target to-be-recommended object to a target object recommendation set of the current user in response to a trigger operation on a target addition control in the at least one addition control, the target to-be-recommended object is a to-be-recommended object that is selected by the current user on the first object page, and the target object recommendation set is an object recommendation set corresponding to the target addition control. By adopting the above technical solution, the present embodiment supports the user to add the to-be-recommended object to different object recommendation sets in the first object page, and recommends the added to-be-recommended object by the user in different recommendation methods, thereby enriching the function of the first object page, the method of adding the to-be-recommended object in the object recommendation set, and the method of recommending the to-be-recommended object.

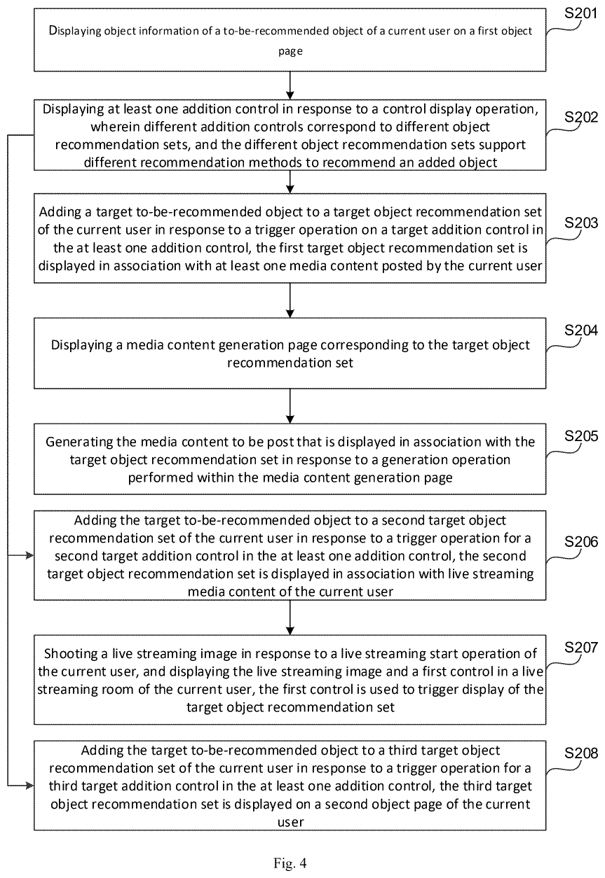

FIG. 4 is a schematic flow diagram of another interaction method provided by an embodiment of the present disclosure. The schemes in this embodiment may be combined with one or more of the alternatives in the above embodiments. Optionally, the media content includes media content to be post and/or live streaming media content, and and the generating associated display content of the target object recommendation set includes: displaying a media content generation page corresponding to the target object recommendation set; and generating the media content to be post that is displayed in association with the target object recommendation set in response to a generation operation performed within the media content generation page; and/or, shooting a live streaming image in response to a live streaming start operation of the current user, and displaying the live streaming image and a first control in a live streaming room of the current user, the first control is used to trigger display of the target object recommendation set.

Optionally, the step of the adding a target to-be-recommended object to a target object recommendation set of the current user in response to a trigger operation on a target addition control in the at least one addition control includes at least one of the following: adding the target to-be-recommended object to a first target object recommendation set of the current user in response to a trigger operation for a first target addition control in the at least one addition control, the first target object recommendation set is displayed in association with at least one media content posted by the current user; adding the target to-be-recommended object to a second target object recommendation set of the current user in response to a trigger operation for a second target addition control in the at least one addition control, the second target object recommendation set is displayed in association with live streaming media content of the current user; and adding the target to-be-recommended object to a third target object recommendation set of the current user in response to a trigger operation for a third target addition control in the at least one addition control, the third target object recommendation set is displayed on a second object page of the current user.

Accordingly, as shown in FIG. 4, the interaction method provided in the present embodiment may include:

S201, displaying object information of a to-be-recommended object of a current user on a first object page, and S202 and/or S205 are executed.

S202, displaying at least one addition control in response to a control display operation, and S203, S206, or S208 is executed, different addition controls correspond to different object recommendation sets, and the different object recommendation sets support different recommendation methods to recommend an added object;

S203, adding a target to-be-recommended object to a target object recommendation set of the current user in response to a trigger operation on a target addition control in the at least one addition control, the first target object recommendation set is displayed in association with at least one media content post by the current user.

The first target addition control may be target addition control corresponding to the first target object recommendation set, that is, an addition control for triggering an instruction to add the target to-be-recommended object to the first target object recommendation set of the current user. The first target object recommendation set may be a target object recommendation set displayed in association with one or more media content post by the current user, and when media content corresponding to the first target object recommendation set is displayed, the first target object recommendation set may be displayed or the first target object recommendation set may be displayed based on the corresponding triggering operation of the viewer.

Exemplarily, as shown in FIG. 3, the first target addition control 31 may be displayed in the addition control panel 30. Thus, when it is detected that the current user triggers the first target addition control 31, the target to-be-recommended object selected by the current user in the first object page may be added to the first target object recommendation set of the current user.

S204: displaying a media content generation page corresponding to the target object recommendation set.

Media content generation page may be a page used to generate to-be-recommended media content, such as a page used to shoot or select media content material. Exemplarily, the media content generation page includes shooting page and/or material page.

In the present embodiment, after the target to-be-recommended object is added to the first target object recommendation set, the media content generation page may be displayed to generate a to-be-post media content corresponding to the first media content recommendation set.

In some embodiments, the media content generation page can be entered by switching from the first object page, such as displaying the media content generation page after the target to-be-recommended object is added to the first target object recommendation set; or, based on a corresponding trigger operation performed by the current user on the first object page, the current page is switched from the first object page to the media content generation page.

In some embodiments, media content generation page can also be entered be entered by switching from recommendation information input page, for example, after adding the target to-be-recommended object to the first target object recommendation set, recommendation information input page can be displayed or recommendation information input page can be displayed based on trigger operation performed by the current user to indicate display of recommendation information input page, so that the current user can input the recommendation information corresponding to the to-be-recommended object added in the first target object recommendation set, and media content generation page can be displayed after the current user's input is completed. At this time, optionally, before the displaying a media content generation page corresponding to the target object recommendation set, the interaction method further includes: displaying a recommendation information input page of the target object recommendation set, the recommendation information input page is used to input recommendation information of an object added to the target object recommendation set for the current user; the displaying a media content generation page corresponding to the target object recommendation set includes: switching a current page from the recommendation information input page to the media content generation page corresponding to the target object recommendation set in response to an input completion operation performed within the recommendation information input page.

The recommendation information input page corresponding to the first target object recommendation set may be a page used for the current user to input the recommendation information of the to-be-recommended object added to the first target object recommendation set. The recommendation information may be understood as information for recommending the corresponding to-be-recommended object, such as a recommendation title and/or a recommendation sentence of the corresponding to-be-recommended object. The input completion operation may be an operation to indicate completion of recommendation information input, such as an operation to trigger an input completion control in recommendation information input page, which may be used to indicate the display of media content generation page.

Exemplarily, after adding the target to-be-recommended object to the first target object recommendation set, a recommendation information input page may be displayed, and when all the target to-be-recommended object selected by the current user are successfully added, the current page may be directly switched to the recommendation information input page corresponding to the first target object recommendation set; when part of the target to-be-recommended objects selected by the current user is successfully added, the second addition information and next-step control may be displayed, the second addition information indicates the number of the target to-be-recommended objects successfully added this time and the number of the target to-be-recommended objects failed to be added this time, and when it is detected that the current user triggers the next-step control, the current page is switched to the recommendation information input page corresponding to the first target object recommendation set.

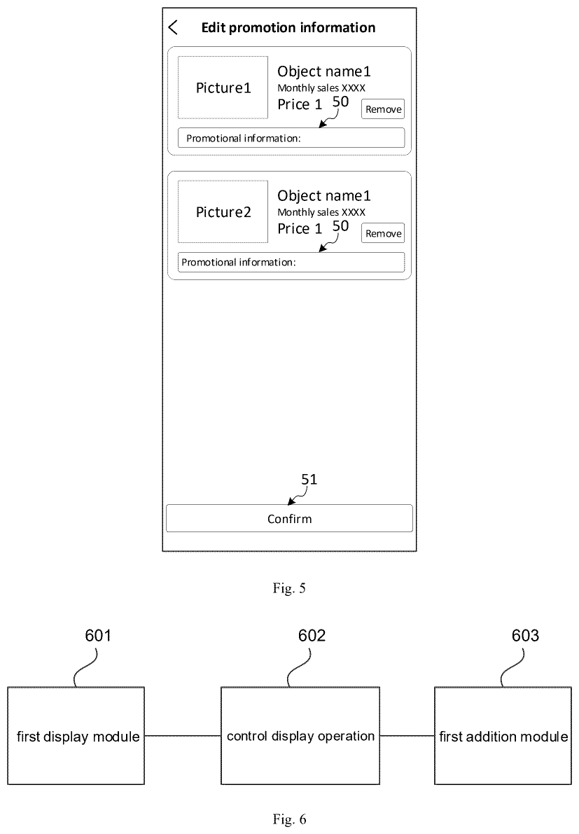

As shown in FIG. 5, the recommendation information input page corresponding to the first target object recommendation set may display information of the to-be-recommended object added to the first target object recommendation set, such as information including picture, name, sales volume, and selling price, and may further include recommendation information input area 50 and input completion control 51 corresponding to the to-be-recommended object added to the first target object recommendation set.

Therefore, the current user can input the recommendation information of the corresponding to-be-recommended object in the recommendation information input area 50 corresponding to the to-be-recommended object, and can trigger the input completion target object 51 in the recommendation information input page after the recommendation information of each to-be-recommended object in the first target object recommendation set is completed.

Accordingly, when the current application detects that the current user triggers the input completion control 51, it may determine that the input completion operation has been received, and in response to the input completion operation, switch the current page from the recommendation information input page corresponding to the first target object recommendation set to the media content generation page.

S205, generating the media content to be post that is displayed in association with the target object recommendation set in response to a generation operation performed within the media content generation page.

The media content to be post may be media content corresponding to the first target object recommendation set, that is, the first target object recommendation set and the media content with which the first target object recommendation is associated and displayed. There is no limit to the type of media content to be post. For example, the media content to be post can be video content or graphic content. The generation operation may be an operation for indicating generation of media content to be post, an operation for indicating to shoot the media content to be post or an operation for indicating to select the material of the media content to be post or the like.

In the present embodiment, when generation operation performed within the media content generation page is received, media content to be post may be generated, such as shooting media content to be post; or selecting and determining the material of the media content to be post, etc., so as to generate the media content to be post based on the selected and determined material.

In some embodiments, the media content generation page includes a shooting page and/or a material page, the generating the media content to be post that is displayed in association with the target object recommendation set in response to a generation operation performed within the media content generation page includes: shooting the media content to be post that is displayed in association with the target object recommendation set in response to a first generation operation performed within the shooting page; and/or generating the media content to be post to be post that is displayed in association with the target object recommendation set based on a material in a selected state in the material page in response to a second generation operation performed within the material page.

The first generation operation may be considered to be a generation operation performed within the shooting page, and exemplarily, the first generation operation may be a shooting operation, such as an operation that triggers the shooting control in the shooting page. The second generation operation may be regarded as the generation operation performed within the material page, and, for example, the second generation operation may be a selection completion operation of material, such as triggering an operation of a selection completion control in a shooting page.

In the above-described embodiment, the media content generation page may be the shooting page, so that when the first generation operation performed within in the shooting page is received, such as when it is detected that the current user triggers the shooting control in the shooting page, the media content picture of the media content to be post can be shoot.

In the above embodiment, the media content generation page may also be the material page, so that the material of the current user can be displayed in the material page, for example, the local material of the current user can be displayed. And when the second generation operation performed within the material page is received, for example, when it is detected that the current user triggers the selection completion control in the material page, the material in the selected state in the material page may be used as the media content material to be post.

In the present embodiment, when the shooting is completed or the material selection is completed, the editing page of the media content to be post may be displayed for the current user to edit the media content to be post, furthermore, after the current user completes editing, the posting page of the media content to be post can be displayed based on the user's posting page display operation, so that the current user can edit the posting information of the media content to be post. Thus, when a posting operation performed within the editing page or posting page is received, the media content edited by the current user can be post. At this time, optionally, after the generating the media content to be post that is displayed in association with the target object recommendation set, the interaction method further includes: posting the media content to be post in response to a posting operation for the media content to be posted. Post operation can be understood as an operation for indicating the posting of media content to be post, such as an operation for triggering the editing page of the media content to be post or the posting control displayed in the posting page.

After the media content to be post is post, the viewer can watch the media content to be post post by the current user, so that when the client of the viewer displays the media content to be post, the first target object recommendation set can be displayed in association, such as further displaying the first target object recommendation set in the display page of the media content to be post; alternatively, when the viewer's client displays the media content to be post, the first target object recommendation set is displayed based on the viewer's trigger operation. The current user may have one or more object recommendation sets that are displayed in association with the media content post by the user, and the media content displayed in association with different object recommendation sets are different.

S206, adding the target to-be-recommended object to a second target object recommendation set of the current user in response to a trigger operation for a second target addition control in the at least one addition control, the second target object recommendation set is displayed in association with live streaming media content of the current user.

The second target addition control may be an addition control corresponding to the second target object recommendation set, that is, an addition control used to trigger an indication for adding the target to-be-recommended object is to the second target object recommendation set of the current user. The second target object recommendation set may be a target object recommendation set displayed in association with the live streaming media content of the current user, and when the live streaming image of the current user is displayed, the second target object recommendation set may be displayed or the second target object recommendation set may be displayed based on the corresponding trigger operation of the viewer, such as during the live streaming of the current user, the second target object recommendation set of the current user is further displayed in the live streaming page of the current user, or the second target object recommendation set of the current user is displayed in the live streaming page of the current user displayed on the client of the audience based on the corresponding trigger operation of the audience.

Exemplarily, as shown in FIG. 3, a second target addition control 32 may be displayed in the addition control panel 30. Thus, when it is detected that the current user triggers the second target addition control 32, the target to-be-recommended object selected by the current user in the first object page may be added to the second target object recommendation set of the current user.

S207, shooting a live streaming image in response to a live streaming start operation of the current user, and displaying the live streaming image and a first control in a live streaming room of the current user, the first control is used to trigger display of the target object recommendation set.

The live streaming start operation can be regarded as a trigger operation for indicating the start of the live streaming, such as an operation of triggering the start of the live streaming control. The first control may be an operation for triggering display of the live streaming object recommendation set of the current user.

In the present embodiment, in the live streaming process of the current user, the live streaming object recommendation set of the current user may be associated and displayed to recommend to-be-recommended objects in the live streaming object recommendation set to audience watching the live streaming.

For example, after the current user starts the live streaming, such as during the live streaming of the current user, the live streaming image of the current user may be shot, and the live streaming image and the first control may be displayed in the live streaming room of the current user. Thus, the user watching the live streaming of the current user may view the second target object recommendation set of the current user by triggering the first control.

S208, adding the target to-be-recommended object to a third target object recommendation set of the current user in response to a trigger operation for a third target addition control in the at least one addition control, the third target object recommendation set is displayed on a second object page of the current user.

The third target addition control may be an addition control corresponding to the third target object recommendation set, that is, an addition control used to trigger indication for adding the target to-be-recommended object to the third target object recommendation set of the current user. The third target object recommendation set may be a target object recommendation set displayed in the third object page of the current user. The second object page may be a page, such as a window page, that displays the third target object recommendation set of the current user to the current user and other users in addition to the current user. Exemplarily, the window control may be displayed in the current user's personal page, and when the window page is triggered by a user viewing the current user's personal control, (such as the current user or other users except the current user), the window page of the current user is displayed in the user's client, and the third target object recommendation set of the current user is displayed in the window page.

For example, as shown in FIG. 4, the third target addition control 33 may be further displayed in the addition control panel 30, so that when it is detected that the current user triggers the third target addition control 33, the target to-be-recommended object selected by the current user in the first object page may be added to the third target object recommendation set of the current user.

By adopting the above-described technical solution, the present embodiment supports adding target to-be-recommended objects to different object recommendation sets, and displays different object recommendation sets of the current user in different display methods, thereby further enriching the adding method and the recommendation method of the to-be-recommended objects, and improving the recommendation experience of the user.

FIG. 6 is a structural block diagram of an interaction apparatus according to an embodiment of the present disclosure. The apparatus may be implemented by software and/or hardware, may be configured in an electronic device, typically, may be configured in a mobile phone or tablet computer, and may add a to-be-recommended object in the first object page to the object recommendation set by performing interaction method. As shown in FIG. 6, the interaction apparatus provided by the present embodiment may include a first display module 601, a control display operation 602, and a first addition module 603.
a first display module 601 is configured to display object information of a to-be-recommended object of a current user on a first object page;
a control display operation 602 is configured to display at least one addition control in response to a control display operation, different addition controls correspond to different object recommendation sets, and the different object recommendation sets support different recommendation methods to recommend an added object;
the first addition module 603 is configured to add a target to-be-recommended object to a target object recommendation set of the current user in response to a trigger operation on a target addition control in the at least one addition control, the target to-be-recommended object is a to-be-recommended object that is selected by the current user on the first object page, and the target object recommendation set is an object recommendation set corresponding to the target addition control.

The interaction apparatus according to the present embodiment display object information of a to-be-recommended object of a current user on a first object page by the first display module; displays at least one addition control in response to a control display operation by the control display operation, different addition controls correspond to different object recommendation sets, and the different object recommendation sets support different recommendation methods to recommend an added object; add a target to-be-recommended object to a target object recommendation set of the current user in response to a trigger operation on a target addition control in the at least one addition control by the first addition module, the target to-be-recommended object is a to-be-recommended object that is selected by the current user on the first object page, and the target object recommendation set is an object recommendation set corresponding to the target addition control. By adopting the above technical solution, the present embodiment supports the user to add the to-be-recommended object in the first object page to different object recommendation sets, and recommends the added to-be-recommended object by the user in different recommendation methods, thereby enriching the functions of the first object page and the way of adding the to-be-recommended object in the object recommendation set, and enriching the way of recommending the to-be-recommended object.

Further, the interaction apparatus provided in the present embodiment may further include: generation module, which is configured to generate associated display content of the target object recommendation set after the adding a target to-be-recommended object to a target object recommendation set of the current user, and the associated display content includes media content.

In the above scheme, the media content may include media content to be post and/or live streaming media content, and the generation module may include: a page display unit, configured to display a media content generation page corresponding to the target object recommendation set; a media content generation unit, configured to generate the media content to be post that is displayed in association with the target object recommendation set in response to a generation operation performed within the media content generation page; and/or a screen shooting unit, configured to shoot a live streaming image in response to a live streaming start operation of the current user, and displaying the live streaming image and a first control in a live streaming room of the current user, the first control is used to trigger display of the target object recommendation set.

In the above scheme, the media content generation page includes a shooting page and/or a material page, and the media content generation unit may be used to: the media content to be post that is displayed in association with the target object recommendation set in response to a first generation operation performed within the shooting page; and/or generate the media content to be post to be post that is displayed in association with the target object recommendation set based on a material in a selected state in the material page in response to a second generation operation performed within the material page.

Further, the interaction apparatus provided in the present embodiment may further include: an information input module, configured to display a recommendation information input page of the target object recommendation set, the recommendation information input page is used to input recommendation information of an object added to the target object recommendation set for the current user, and the recommendation information input page is used for switching a current page from the recommendation information input page to the media content generation page corresponding to the target object recommendation set in response to an input completion operation performed within the recommendation information input page.

Further, the interaction apparatus provided by the present embodiment may further include a posting module, configured to post the media content to be post in response to a posting operation for the media content to be posted after the generating the media content to be post that is displayed in association with the target object recommendation set.

In the above scheme, the first addition module 603 may be configured to perform at least one of the following: adding the target to-be-recommended object to a first target object recommendation set of the current user in response to a trigger operation for a first target addition control in the at least one addition control, the first target object recommendation set is displayed in association with at least one media content posted by the current user; adding the target to-be-recommended object to a second target object recommendation set of the current user in response to a trigger operation for a second target addition control in the at least one addition control, the second target object recommendation set is displayed in association with live streaming media content of the current user; and adding the target to-be-recommended object to a third target object recommendation set of the current user in response to a trigger operation for a third target addition control in the at least one addition control, the third target object recommendation set is displayed on a second object page of the current user.

Further, the interaction apparatus provided in the present embodiment may further include at least one of the following: a second display module, configured to display the target object recommendation set after the adding a target to-be-recommended object to a target object recommendation set of the current user; an information display module, configured to display addition information of the target to-be-recommended object, the addition information is used to indicate whether the target to-be-recommended object is successfully added and/or a reason why the target to-be-recommended object fails to be added; and/or
a page display module, configured to display a third object page before the displaying object information of a to-be-recommended object of a current user on a first object page, object information of at least one candidate recommendation object and a second control corresponding to a display theme of the third object page are displayed in the third object page; a second addition module, configured to add a first candidate recommendation object to the first object page of the current user in response to an object addition operation for the first candidate recommendation object in the at least one candidate recommendation object; and; a third addition module, configured to a second candidate recommendation object corresponding to the second control to an object recommendation set corresponding to the display theme in response to a trigger operation of the second control.

The interaction apparatus provided by the embodiment of the present disclosure can execute the interaction method provided by any embodiment of the present disclosure, and has functional modules and beneficial effects corresponding to the execution of the interaction method. For technical details not described in detail in this embodiment, please refer to the interaction method provided by any embodiment of this disclosure.

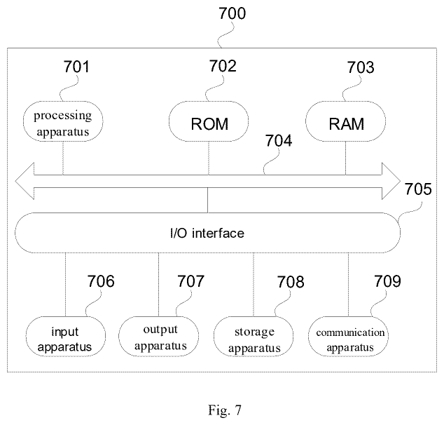

Referring to FIG. 7 below shows a schematic structural diagram of an electronic device (e.g., terminal device) 700 suitable for use in implementing embodiments of the present disclosure. The terminal device in the embodiment of the present disclosure may include, but is not limited to, a mobile terminal such as a mobile phone, a notebook computer, a digital broadcast receiver, a PDA (personal digital assistant), a PAD (Tablet PC), a PMP (Portable Multimedia Player), an in-vehicle terminal (for example, an in-vehicle navigation terminal), and the like, and a fixed terminal such as a digital TV, a desktop computer, and the like. The electronic device illustrated in FIG. 7 is merely an example, and should not impose any limitation on the functionality and scope of use of the embodiments of the present disclosure.

As shown in FIG. 7, the electronic device 700 may include a processing apparatus (e.g., central processing unit, graphics processing unit, etc.) 701 that may perform various appropriate actions and processes according to a program stored in the read-only memory (ROM) 702 or a program loaded from the storage apparatus 708 into the random-access memory (RAM) 703. In the RAM 703, various programs and data necessary for the operation of the electronic device 700 are also stored. The processing apparatus 701, the ROM 702, and the RAM 703 are connected to each other by a bus 704. An input/output (I/O) interface 705 is also connected to the bus 704.

Generally, the following devices may be connected to the I/O interface 705: input apparatus 706 including, for example, touchscreen, accelerometer, keyboard, mouse, camera, microphone, gyroscope, input apparatus, etc.; an output apparatus 707 including, for example, a liquid crystal display (LCD), a speaker, a vibrator, and the like; storage apparatus 708 including, for example, magnetic tape, hard disk, etc.; and communication apparatus 709. The communication apparatus 709 may allow the electronic device 700 to communicate wirelessly or wired with other devices to exchange data. While FIG. 7 shows an electronic device 700 with various devices, it should be understood that it is not required that all of the devices shown be implemented or provided. More or fewer devices may alternatively be implemented or provided.

In particular, according to embodiments of the present disclosure, the process described above in the referring to flowchart may be implemented as a computer software program. For example, embodiments of the present disclosure include a computer program product including a computer program carried on a non-transitory computer-readable medium, the computer program containing program code for performing the method shown in the flowchart. In such embodiments, the computer program may be downloaded and installed from the network via communication apparatus 709, or installed from storage apparatus 708, or installed from ROM 702. When the computer program is executed by the processing apparatus 701, the above-described functions defined in the method of the embodiment of the present disclosure are executed.

The computer-readable medium of the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or a combination of any of the above. More specific examples of computer-readable storage medium may include, but are not limited to, electrical connections with one or more wires, portable computer magnetic disk, hard disk, random access memory (RAM), read-only memory (ROM), erasable programmable read-only memory (EPROM or Flash), optical fiber, portable compact disc read-only memory (CD-ROM), optical storage device, magnetic storage device, or any suitable combination of the foregoing. In the present disclosure, computer-readable storage medium may be any tangible medium containing or storing a program that may be used by or in conjunction with an instruction execution system, apparatus, or device. Whereas in the present disclosure, a computer-readable signal medium may include a data signal propagated in a baseband or as part of a carrier wave, carrying computer-readable program code therein. Such propagated data signals may take a variety of forms, including, but not limited to, electromagnetic signals, optical signals, or any suitable combination of the foregoing. The computer-readable signal medium may also be any computer-readable medium other than the computer-readable storage medium that may transmit, propagate, or transmit a program for use by or in connection with an instruction execution system, apparatus, or device. The program code contained on the computer-readable medium may be transmitted using any suitable medium including, but not limited to, wires, optical cables, RF (radio frequency), or the like, or any suitable combination of the foregoing.

In some embodiments, the client, server may communicate using any currently known or future developed network protocol such as HTTP (HyperText Transfer Protocol), and may be interconnected with any form or medium of digital data communication (e.g., a communication network). Examples of communication networks include local area networks (“LAN”), wide area networks (“WAN”), the Internet (e.g., the Internet), and end-to-end networks (e.g., ad hoc end-to-end networks), as well as any currently known or future-developed networks.

The computer-readable medium may be included in the electronic device described above; it may also exist alone without being fitted into the electronic device.

The computer-readable medium carries one or more programs, and when the one or more programs are executed by the electronic device, the electronic device: displaying object information of a to-be-recommended object of a current user on a first object page; displaying at least one addition control in response to a control display operation, different addition controls correspond to different object recommendation sets, and the different object recommendation sets support different recommendation methods to recommend an added object; adding a target to-be-recommended object to a target object recommendation set of the current user in response to a trigger operation on a target addition control in the at least one addition control, the target to-be-recommended object is a to-be-recommended object that is selected by the current user on the first object page, and the target object recommendation set is an object recommendation set corresponding to the target addition control.

Computer program code for performing the operations of the present disclosure may be written in one or more programming languages, or combinations thereof, including, but not limited to, object-oriented programming languages such as Java, Smalltalk, C++, but also conventional procedural programming languages such as the “C” language or similar programming languages. The program code may be executed entirely on the user's computer, partially on the user's computer, as a standalone software package, partially on the user's computer and partially on a remote computer, or entirely on a remote computer or server. In cases involving a remote computer, the remote computer may be connected to the user computer through any kind of network, including a local area network (LAN) or a wide area network (WAN), or may be connected to an external computer (e.g., using an Internet service provider to connect over the Internet).

Flowcharts and block diagrams in the drawings illustrate the architecture, functionality, and operation of possible implementations of systems, methods, and computer program product in accordance with various embodiments of the present disclosure. In this regard, each block in the flowchart or block diagram may represent a module, program segment, or portion of code that contains one or more executable instructions for implementing a specified logical function. It should also be noted that, in some alternative implementations, the functions noted in the blocks may also occur in a different order than that noted in the figures. For example, two blocks represented in succession may actually be executed substantially in parallel, and they may sometimes be executed in reverse order, depending on the function involved. It is also noted that each block in the block diagrams and/or flowchart diagrams, and combinations of blocks in the block diagrams and/or flowchart diagrams, may be implemented with a dedicated hardware-based system that performs the specified functions or operations, or may be implemented with a combination of dedicated hardware and computer instructions.

The units described in the embodiments of the present disclosure may be implemented by software or hardware. Among them, the name of the module does not constitute a limitation of the unit itself in some cases.

The functions described above herein may be performed, at least in part, by one or more hardware logic components. For example, and without limitation, exemplary types of hardware logic components that may be used include Field Programmable Gate Arrays (FPGAs), Application Specific Integrated Circuits (ASICs), Application Specific Standard Products (ASSPs), Systems on tile (SOCs), Complex Programmable Logic Devices (CPLDs), and the like.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage medium may include one or more wire-based electrical connections, portable computer disks, hard disk, random access memory (RAM), read-only memory (ROM), erasable programmable read-only memory (EPROM or Flash memory), optical fiber, handy compact disk read-only memory (CD-ROM), optical storage devices, magnetic storage devices, or any suitable combination of the foregoing.

According to one or more embodiments of the present disclosure, there is provided an interaction method including:
displaying object information of a to-be-recommended object of a current user on a first object page;
displaying at least one addition control in response to a control display operation, different addition controls correspond to different object recommendation sets, and the different object recommendation sets support different recommendation methods to recommend an added object;
adding a target to-be-recommended object to a target object recommendation set of the current user in response to a trigger operation on a target addition control in the at least one addition control, the target to-be-recommended object is a to-be-recommended object that is selected by the current user on the first object page, and the target object recommendation set is an object recommendation set corresponding to the target addition control.

According to one or more embodiments of the present disclosure, Example 2 The method of Example 1, after the adding a target to-be-recommended object to a target object recommendation set of the current user, further including:
generating associated display content of the target object recommendation set, the associated display content includes media content.

According to one or more embodiments of the present disclosure, the media content includes media content to be post and/or live streaming media content, and the generating associated display content of the target object recommendation set includes:
displaying a media content generation page corresponding to the target object recommendation set; and generating the media content to be post that is displayed in association with the target object recommendation set in response to a generation operation performed within the media content generation page; and/or
shooting a live streaming image in response to a live streaming start operation of the current user, and displaying the live streaming image and a first control in a live streaming room of the current user, the first control is used to trigger display of the target object recommendation set.

According to one or more embodiments of the present disclosure, the media content generation page includes a shooting page and/or a material page, the generating the media content to be post that is displayed in association with the target object recommendation set in response to a generation operation performed within the media content generation page including:
shooting the media content to be post that is displayed in association with the target object recommendation set in response to a first generation operation performed within the shooting page; and/or generating the media content to be post to be post that is displayed in association with the target object recommendation set based on a material in a selected state in the material page in response to a second generation operation performed within the material page.

According to one or more embodiments of the present disclosure, before the displaying a media content generation page corresponding to the target object recommendation set, the interaction method further includes:
displaying a recommendation information input page of the target object recommendation set, the recommendation information input page is used to input recommendation information of an object added to the target object recommendation set for the current user;
the displaying a media content generation page corresponding to the target object recommendation set includes:
switching a current page from the recommendation information input page to the media content generation page corresponding to the target object recommendation set in response to an input completion operation performed within the recommendation information input page.

According to one or more embodiments of the present disclosure, after the generating the media content to be post that is displayed in association with the target object recommendation set, the interaction method further includes:
posting the media content to be post in response to a posting operation for the media content to be posted.

According to one or more embodiments of the present disclosure, the adding a target to-be-recommended object to a target object recommendation set of the current user in response to a trigger operation on a target addition control in the at least one addition control includes at least one of the following:
adding the target to-be-recommended object to a first target object recommendation set of the current user in response to a trigger operation for a first target addition control in the at least one addition control, the first target object recommendation set is displayed in association with at least one media content posted by the current user;
adding the target to-be-recommended object to a second target object recommendation set of the current user in response to a trigger operation for a second target addition control in the at least one addition control, the second target object recommendation set is displayed in association with live streaming media content of the current user; and
adding the target to-be-recommended object to a third target object recommendation set of the current user in response to a trigger operation for a third target addition control in the at least one addition control, the third target object recommendation set is displayed on a second object page of the current user.

According to one or more embodiments of the present disclosure, after the adding a target to-be-recommended object to a target object recommendation set of the current user, the interaction method further includes at least one of the following:
displaying the target object recommendation set; and
displaying addition information of the target to-be-recommended object, the addition information is used to indicate whether the target to-be-recommended object is successfully added and/or a reason why the target to-be-recommended object fails to be added; and/or
before the displaying object information of a to-be-recommended object of a current user on a first object page, the interaction method further includes:
displaying a third object page, object information of at least one candidate recommendation object and a second control corresponding to a display theme of the third object page are displayed in the third object page;
adding a first candidate recommendation object to the first object page of the current user in response to an object addition operation for the first candidate recommendation object in the at least one candidate recommendation object; and
adding a second candidate recommendation object corresponding to the second control to an object recommendation set corresponding to the display theme in response to a trigger operation of the second control.

According to one or more embodiments of the present disclosure, an interaction apparatus is provided, and the interaction apparatus includes:
a first display module, configured to display object information of a to-be-recommended object of a current user on a first object page;
a control display operation, configured to display at least one addition control in response to a control display operation, different addition controls correspond to different object recommendation sets, and the different object recommendation sets support different recommendation methods to recommend an added object; and
a first addition module, configured to add a target to-be-recommended object to a target object recommendation set of the current user in response to a trigger operation on a target addition control in the at least one addition control, the target to-be-recommended object is a to-be-recommended object that is selected by the current user on the first object page, and the target object recommendation set is an object recommendation set corresponding to the target addition control.

According to one or more embodiments of the present disclosure, there is provided an electronic device including:
one or more processor;
memory for storing one or more programs,
when the one or more programs are executed by the one or more processor, the one or more processor implements the interaction method of any one of the embodiments of the present disclosure.

According to one or more embodiments of the present disclosure, a computer-readable storage medium having computer program stored thereon is provided, when the program is executed by the processor, the interactive method described in any of the embodiments of the present disclosure is implemented.

The above description is merely an explanation of preferred embodiments of the present disclosure and the technical principles employed. Those skilled in the art should understand that the scope of disclosure in the present disclosure is not limited to technical solutions formed by specific combinations of the above-described technical feature rights, and should also cover other technical solutions formed by arbitrary combinations of the above-described technical feature rights or their equivalent features without departing from the concept of the above-described disclosure. For example, the above-described features are mutually replaced with technical feature having similar functions disclosed in the present disclosure (but not limited to).

Furthermore, while operations are depicted in a particular order, this should not be understood as requiring the operations to be performed in the particular order shown or in a sequential order. Under certain circumstances, multi-task and parallel processing may be advantageous. Likewise, while several specific implementation details are included in the above discussion, these should not be construed as limiting the scope of the present disclosure. Certain features described in the context of separate embodiments may also be implemented in combination in a single embodiment. Conversely, the various features described in the context of a single embodiment may also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. Rather, the specific features and acts described above are merely exemplary forms for implementing the claims.

1. An interaction method, comprising:
displaying object information of a to-be-recommended object of a current user on a first object page;
displaying at least one addition control in response to a control display operation, wherein different addition controls correspond to different object recommendation sets, and the different object recommendation sets support different recommendation methods to recommend an added object;
adding a target to-be-recommended object to a target object recommendation set of the current user in response to a trigger operation on a target addition control in the at least one addition control, wherein the target to-be-recommended object is a to-be-recommended object that is selected by the current user on the first object page, and the target object recommendation set is an object recommendation set corresponding to the target addition control.

2. The interaction method according to claim 1, wherein after the adding a target to-be-recommended object to a target object recommendation set of the current user, the interaction method further comprises:
generating associated display content of the target object recommendation set, wherein the associated display content comprises media content.

3. The interaction method according to claim 2, wherein the media content comprises media content to be post and/or live streaming media content, and the generating associated display content of the target object recommendation set comprises:
displaying a media content generation page corresponding to the target object recommendation set; and generating the media content to be post that is displayed in association with the target object recommendation set in response to a generation operation performed within the media content generation page; and/or
shooting a live streaming image in response to a live streaming start operation of the current user, and displaying the live streaming image and a first control in a live streaming room of the current user, wherein the first control is used to trigger display of the target object recommendation set.

4. The interaction method according to claim 3, wherein the media content generation page comprises a shooting page and/or a material page, the generating the media content to be post that is displayed in association with the target object recommendation set in response to a generation operation performed within the media content generation page comprises:
shooting the media content to be post that is displayed in association with the target object recommendation set in response to a first generation operation performed within the shooting page; and/or
generating the media content to be post to be post that is displayed in association with the target object recommendation set based on a material in a selected state in the material page in response to a second generation operation performed within the material page.

5. The interaction method according to claim 3, wherein before the displaying a media content generation page corresponding to the target object recommendation set, the interaction method further comprises:
displaying a recommendation information input page of the target object recommendation set, wherein the recommendation information input page is used to input recommendation information of an object added to the target object recommendation set for the current user;
the displaying a media content generation page corresponding to the target object recommendation set comprises:
switching a current page from the recommendation information input page to the media content generation page corresponding to the target object recommendation set in response to an input completion operation performed within the recommendation information input page.

6. The interaction method according to claim 3, wherein after the generating the media content to be post that is displayed in association with the target object recommendation set, the interaction method further comprises:
posting the media content to be post in response to a posting operation for the media content to be posted.

7. The interaction method according to claim 1, wherein the adding a target to-be-recommended object to a target object recommendation set of the current user in response to a trigger operation on a target addition control in the at least one addition control comprises at least one selected from a group consisting of:
adding the target to-be-recommended object to a first target object recommendation set of the current user in response to a trigger operation for a first target addition control in the at least one addition control, wherein the first target object recommendation set is displayed in association with at least one media content posted by the current user;
adding the target to-be-recommended object to a second target object recommendation set of the current user in response to a trigger operation for a second target addition control in the at least one addition control, wherein the second target object recommendation set is displayed in association with live streaming media content of the current user; and
adding the target to-be-recommended object to a third target object recommendation set of the current user in response to a trigger operation for a third target addition control in the at least one addition control, wherein the third target object recommendation set is displayed on a second object page of the current user.

8. The interaction method according to claim 1, wherein after the adding a target to-be-recommended object to a target object recommendation set of the current user, the interaction method further comprises at least one selected from a group consisting of:
displaying the target object recommendation set; and
displaying addition information of the target to-be-recommended object, wherein the addition information is used to indicate whether the target to-be-recommended object is successfully added and/or a reason why the target to-be-recommended object fails to be added; and/or
before the displaying object information of a to-be-recommended object of a current user on a first object page, the interaction method further comprises:
displaying a third object page, wherein object information of at least one candidate recommendation object and a second control corresponding to a display theme of the third object page are displayed in the third object page;
adding a first candidate recommendation object to the first object page of the current user in response to an object addition operation for the first candidate recommendation object in the at least one candidate recommendation object; and
adding a second candidate recommendation object corresponding to the second control to an object recommendation set corresponding to the display theme in response to a trigger operation of the second control.

9. (canceled)

10. An electronic device, comprising:
at least one processor; and
a memory communicatively connected to the at least one processor; wherein the memory stores computer programs executable by the at least one processor, the computer programs are executed by the at least one processor so that the at least one processor performs an interaction method, and the interaction method comprises:
displaying object information of a to-be-recommended object of a current user on a first object page:
displaying at least one addition control in response to a control display operation, wherein different addition controls correspond to different object recommendation sets, and the different object recommendation sets support different recommendation methods to recommend an added object:
adding a target to-be-recommended object to a target object recommendation set of the current user in response to a trigger operation on a target addition control in the at least one addition control, wherein the target to-be-recommended object is a to-be-recommended object that is selected by the current user on the first object page, and the target object recommendation set is an object recommendation set corresponding to the target addition control.

11. A non-transitory computer-readable storage medium, wherein the non-transitory computer-readable storage medium stores computer instructions, the computer instructions are used to cause the processor to implement an interaction method when executed, and the interaction method comprises:
displaying object information of a to-be-recommended object of a current user on a first object page:
displaying at least one addition control in response to a control display operation, wherein different addition controls correspond to different object recommendation sets, and the different object recommendation sets support different recommendation methods to recommend an added object; adding a target to-be-recommended object to a target object recommendation set of the current user in response to a trigger operation on a target addition control in the at least one addition control, wherein the target to-be-recommended object is a to-be-recommended object that is selected by the current user on the first object page, and the target object recommendation set is an object recommendation set corresponding to the target addition control.

12. The electronic device according to claim 10, wherein after the adding a target to-be-recommended object to a target object recommendation set of the current user, the interaction method further comprises:
generating associated display content of the target object recommendation set, wherein the associated display content comprises media content.

13. The electronic device according to claim 12, wherein the media content comprises media content to be post and/or live streaming media content, and the generating associated display content of the target object recommendation set comprises:
displaying a media content generation page corresponding to the target object recommendation set; and generating the media content to be post that is displayed in association with the target object recommendation set in response to a generation operation performed within the media content generation page; and/or
shooting a live streaming image in response to a live streaming start operation of the current user, and displaying the live streaming image and a first control in a live streaming room of the current user, wherein the first control is used to trigger display of the target object recommendation set.

14. The electronic device according to claim 13, wherein the media content generation page comprises a shooting page and/or a material page, the generating the media content to be post that is displayed in association with the target object recommendation set in response to a generation operation performed within the media content generation page comprises:
shooting the media content to be post that is displayed in association with the target object recommendation set in response to a first generation operation performed within the shooting page; and/or
generating the media content to be post to be post that is displayed in association with the target object recommendation set based on a material in a selected state in the material page in response to a second generation operation performed within the material page.

15. The electronic device according to claim 13, wherein before the displaying a media content generation page corresponding to the target object recommendation set, the interaction method further comprises:
displaying a recommendation information input page of the target object recommendation set, wherein the recommendation information input page is used to input recommendation information of an object added to the target object recommendation set for the current user;
the displaying a media content generation page corresponding to the target object recommendation set comprises:
switching a current page from the recommendation information input page to the media content generation page corresponding to the target object recommendation set in response to an input completion operation performed within the recommendation information input page.

16. The electronic device according to claim 13, wherein after the generating the media content to be post that is displayed in association with the target object recommendation set, the interaction method further comprises:
posting the media content to be post in response to a posting operation for the media content to be posted.

17. The electronic device according to claim 10, wherein the adding a target to-be-recommended object to a target object recommendation set of the current user in response to a trigger operation on a target addition control in the at least one addition control comprises at least one selected from a group consisting of:
adding the target to-be-recommended object to a first target object recommendation set of the current user in response to a trigger operation for a first target addition control in the at least one addition control, wherein the first target object recommendation set is displayed in association with at least one media content posted by the current user;
adding the target to-be-recommended object to a second target object recommendation set of the current user in response to a trigger operation for a second target addition control in the at least one addition control, wherein the second target object recommendation set is displayed in association with live streaming media content of the current user; and
adding the target to-be-recommended object to a third target object recommendation set of the current user in response to a trigger operation for a third target addition control in the at least one addition control, wherein the third target object recommendation set is displayed on a second object page of the current user.

18. The electronic device according to claim 10, wherein after the adding a target to-be-recommended object to a target object recommendation set of the current user, the interaction method further comprises at least one selected from a group consisting of:
displaying the target object recommendation set; and
displaying addition information of the target to-be-recommended object, wherein the addition information is used to indicate whether the target to-be-recommended object is successfully added and/or a reason why the target to-be-recommended object fails to be added; and/or
before the displaying object information of a to-be-recommended object of a current user on a first object page, the interaction method further comprises:
displaying a third object page, wherein object information of at least one candidate recommendation object and a second control corresponding to a display theme of the third object page are displayed in the third object page;
adding a first candidate recommendation object to the first object page of the current user in response to an object addition operation for the first candidate recommendation object in the at least one candidate recommendation object; and
adding a second candidate recommendation object corresponding to the second control to an object recommendation set corresponding to the display theme in response to a trigger operation of the second control.

19. The non-transitory computer-readable storage medium according to claim 11, after the adding a target to-be-recommended object to a target object recommendation set of the current user, the interaction method further comprises:
generating associated display content of the target object recommendation set, wherein the associated display content comprises media content.

20. The non-transitory computer-readable storage medium according to claim 19, wherein the media content comprises media content to be post and/or live streaming media content, and the generating associated display content of the target object recommendation set comprises:
displaying a media content generation page corresponding to the target object recommendation set; and
generating the media content to be post that is displayed in association with the target object recommendation set in response to a generation operation performed within the media content generation page; and/or
shooting a live streaming image in response to a live streaming start operation of the current user, and displaying the live streaming image and a first control in a live streaming room of the current user, wherein the first control is used to trigger display of the target object recommendation set.

21. The non-transitory computer-readable storage medium according to claim 20, wherein the media content generation page comprises a shooting page and/or a material page, the generating the media content to be post that is displayed in association with the target object recommendation set in response to a generation operation performed within the media content generation page comprises:
shooting the media content to be post that is displayed in association with the target object recommendation set in response to a first generation operation performed within the shooting page; and/or
generating the media content to be post to be post that is displayed in association with the target object recommendation set based on a material in a selected state in the material page in response to a second generation operation performed within the material page.
